(19) United States
(12) Patent Application Publication
(10) Pub. No.: US 2008/0181998 A1
(43) Pub. Date: Jul. 31, 2008

(54) Process for processing foodstuffs to prolong freshness

(75) Inventors: Douglas A. Cossette, Kindred, ND (US); David D. Cossette, Barnesville, MN (US)

Correspondence Address: WOODS FULLER SHULTZ & SMITH P.C.;ATTN: JEFFREY A. PROEHL, P.O. BOX 5027, SIOUX FALLS, SD, 57117, US

(73) Assignee: DAKOTA VALLEY PRODUCTS, INC.

(21) Appl. No.: 11/699,248

(22) Filed: Jan. 29, 2007

(51) Int. Cl. B65B 25/00; A23L 1/00; A23L 1/01

(52) U.S. Cl. 426/392; 426/520; 426/442; 426/523

(57) ABSTRACT

A method of processing foodstuffs is disclosed that comprises providing a foodstuff, heating the foodstuff, cooling the foodstuff from a first temperature; and displacing oxygen in the foodstuff with nitrogen, including exposing the foodstuff to a nitrogen rich environment in a vessel and applying a negative pressure condition to the foodstuff in the vessel to force nitrogen into the foodstuff.

### BACKGROUND OF THE INVENTION

1. Field of the Invention

The present invention relates to foodstuff processing and more particularly pertains to a new process for processing foodstuffs to prolong freshness for increasing the shelf life of packaged foodstuffs.

2. Description of the Prior Art

Foodstuffs, and as an example snack foods such as prepared seeds, legumes, and nuts, are packaged and distributed to various points of distribution such as grocery and convenience stores where the packages may remain for long periods of time prior to sale, and then may also spend a long period of time in the possession of the consumer before the foodstuff is actually eaten. The packages of the foodstuffs are typically labeled with a date that is usually a prediction of the time period that the foodstuff will retain its desired level of freshness when properly stored. The date may be the date by which the foodstuff should be sold by the store to the consumer, or in some cases the date by which the foodstuff should actually be consumed. In either case, the time which the product remains saleable is limited, and after these time periods unsold packages of the foodstuff will have to be removed from the shelf and destroyed. Clearly, the destruction of unsold and unconsumed product at the end of the freshness period is wasteful and should be avoided, or at least minimized to the extent possible.

Freshness of a foodstuff is negatively affected by the presence of air, or more particularly oxygen, in contact with the foodstuff, such as in the packaging. Thus, removal of as much oxygen from the environment of the foodstuff prior to packaging and in the package is desirable. Foodstuffs such as the aforementioned seeds, legumes and nuts that are processed and packed in their shells can be especially challenging in this regard, as the interior of the shell can provide a void that shelters or traps air or oxygen either naturally occurring or introduced during the processing of the foodstuff, such as by drying or fluid removal processes.

In view of the foregoing, it is believed that there is a need for a process for foodstuffs that eliminates or minimizes the amount of oxygen that is present in the foodstuff and even in the packaging for the foodstuff.

### SUMMARY OF THE INVENTION

To avoid the drawbacks of the prior art that affect freshness of packaged foodstuffs and thus can diminish the shelf life of the packaged foodstuffs, the present invention generally comprises a method of processing foodstuffs is disclosed that comprises providing a foodstuff, heating the foodstuff, cooling the foodstuff from a first temperature; and displacing oxygen in the foodstuff with nitrogen, including exposing the foodstuff to a nitrogen rich environment in a vessel and applying a negative pressure condition to the foodstuff in the vessel to force nitrogen into the foodstuff.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One advantage of the invention is to displace oxygen from a foodstuff that would negatively affect freshness, and thus the shelf life of the packaged foodstuff. Another advantage that may be provided by the invention is the termination of a roasting process of the foodstuff due to the influx into the foodstuff of relatively cool nitrogen.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWING

The invention will be better understood and objects of the invention will become apparent when consideration is given to the following detailed description thereof. Such description makes reference to the annexed drawing wherein:

FIG. 1 is a schematic flow diagram of a new method of processing foodstuffs to prolong freshness according to the present invention.

### DESCRIPTION OF PREFERRED EMBODIMENTS

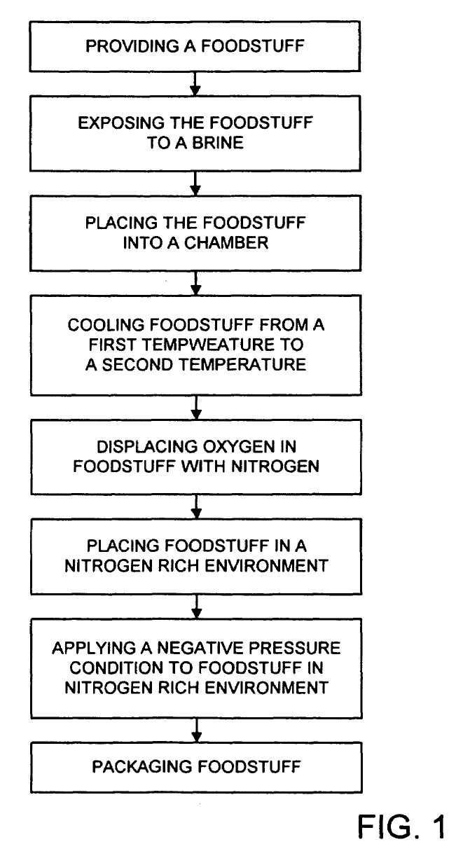

With reference now to the drawing, and in particular to FIG. 1 thereof, a new sunflower processing system embodying the principles and concepts of the present invention will be described.

The invention is primarily directed to a method of processing or preparing a foodstuff in a manner that provides a foodstuff that is less affected by the negative effects of oxygen after the foodstuff has been prepared, and prolongs freshness so that when the foodstuff is placed in packaging, the foodstuff is more likely to have a relatively longer shelf life, or period over which the foodstuff may be sold before the freshness of the foodstuff is decreased and cannot be sold to a consumer.

Broadly, suitable foodstuffs for use in the invention include foods that are typically dried or roasted or both dried and roasted to form a prepared snack food. Such foodstuffs may include internal interstices that may be penetrated by a fluid when a relatively low pressure condition is applied to the foodstuff, so that the fluid (and compositions carried in the fluid) may impregnate the foodstuff.

More particularly, suitable foodstuffs for use in the invention may include seeds, legumes, and nuts, although other edibles, and especially those edibles commonly used as snack-type foods, may be utilized. The foodstuffs may include the protective shells, or may be removed any protective shell that covers the foodstuff. Exemplary seeds include, for example, sunflower seeds, and the like. Exemplary legumes include peanuts, soybeans, and the like. Exemplary nuts include both botanical nuts (which are encompassed by the botanical definition of a “seed”) and foodstuffs that are referred to as “nuts” in culinary parlance, and may include almonds, Brazil nuts, cashews, macadamia nuts, pine nuts, pistachio nuts, and the like.

The method of processing foodstuffs includes providing the foodstuff for the process, and the foodstuff is typically processed in batch quantities, and not on an individual basis. Such quantities may be up to and even exceed 1500 pounds of the foodstuff.

In some implementations of the invention, the foodstuff may preliminarily be exposed to a brine that contains a salt. The foodstuff may be placed into a chamber for the processing. The foodstuff and brine may then be processed to cause the brine, or components of the brine, to be absorbed into the foodstuff, such as by the application of a negative or low pressure condition in the chamber to the foodstuff and brine. The remaining or residual brine may be removed from the foodstuff, and the foodstuff may be dried. After drying, the foodstuff may be heated, and thus may be roasted.

In one implementation of the invention, after heating the foodstuff, the foodstuff is initially cooled from a first temperature that is substantially equal to the roasting temperature. The first temperature may be in the range of approximately 290 degrees Fahrenheit to approximately 300 degrees Fahrenheit. This initial cooling may be performed by exposing the foodstuff to a forced flow of air through the batch of the foodstuff. The cooling of the foodstuff is preferably accomplished in a rapid manner, bringing the temperature of the foodstuff down to a second temperature. The rapid cooling may occur over a period of approximately 180 seconds to approximately 300 seconds, although the cooling may be accomplished in a faster manner so that the cooling period is shorter than 3 minutes. The second temperature may be approximately 80 degrees Fahrenheit, although some variation from this temperature is acceptable.

In a significant aspect of the invention, oxygen or other gases in the foodstuff are displaced by nitrogen. This displacement may be accomplished by placing the foodstuff in a vessel, such as vessel that is suitable for applying a low or negative pressure condition to the contents. Further, the foodstuff is exposed to an environment that is rich in nitrogen than air, and may be at least 90 percent or greater nitrogen. Preferably, although not necessarily critically, the nitrogen rich environment is approximately 99.9 percent nitrogen. Once the foodstuff is exposed to and in the presence of the nitrogen rich environment, a negative or low pressure condition is applied to the foodstuff in the chamber, as well as the nitrogen in the vessel. The negative pressure condition is measured relative to normal atmospheric pressure or the atmospheric pressure in the environment of the vessel. In some implementations of the invention, the negative pressure condition is approximately 29 inches Hg. Significantly, the application of the low or negative pressure environment condition to the foodstuff in the nitrogen rich environment not only drives the nitrogen into the cavities and interstices of the foodstuff, but the influx of the nitrogen into the foodstuff may function to further cool the food stuff from the second temperature to a third, lower temperature to complete the cooling process. The third temperature may be approximately 70 degrees Fahrenheit (or approximately room temperature). The resultant cooling effectively ends the roasting of the foodstuff. The foodstuff is thus immersed in the nitrogen rich environment, with interstitial spaces of the foodstuff being filled to a large extent with nitrogen rather than air or oxygen.

The batch of the foodstuff may be transferred or placed in a container with a closed bottom such that any nitrogen leaking or dissipating from the foodstuff passively remains in the interior of the container as the nitrogen (N2) is relatively heavier than the oxygen (O2) present in the atmosphere. The container may be lined, and the liner may be flexible.

The foodstuff may then be packaged in smaller quantities in individual packages with the nitrogen remaining present in the foodstuff. In other words, the nitrogen is not driven out of the foodstuff, as its residual presence displaces oxygen that would other function to degrade the freshness of the foodstuff.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method of processing foodstuffs, comprising:
providing a foodstuff;
heating the foodstuff;
cooling the foodstuff from a first temperature; and
displacing oxygen in the foodstuff with nitrogen, including:
exposing the foodstuff to a nitrogen rich environment in a vessel; and
applying a negative pressure condition to the foodstuff in the vessel to force nitrogen into the foodstuff.

2. The method of claim 1 additionally comprising packaging the foodstuff without removing the nitrogen forced into the foodstuff.

3. The method of claim 1 additionally comprising exposing the foodstuff to a brine prior to heating the foodstuff.

4. The method of claim 1 wherein heating the foodstuff includes roasting the foodstuff in a substantially dry condition.

5. The method of claim 1 wherein cooling the foodstuff includes exposing the foodstuff to a forced flow of air through the foodstuff.

6. The method of claim 5 wherein cooling the foodstuff includes bringing the temperature of the foodstuff from the first temperature to a second temperature, wherein the cooling from the first temperature to the second temperature is accomplished in a period of less than approximately 300 seconds.

7. The method of claim 6 wherein the second temperature being approximately 80 degrees Fahrenheit.

8. The method of claim 1 additionally comprising placing the foodstuff in a container with a closed bottom such that any nitrogen dissipating from the foodstuff passively remains in an interior of the container.

9. The method of claim 1 wherein the nitrogen rich environment includes at least 90 percent nitrogen.

10. The method of claim 1 wherein the negative pressure condition is approximately 29 inches Hg.

11. The method of claim 1 additionally comprising packaging the foodstuff without removing the nitrogen forced into the foodstuff;
exposing the foodstuff to a brine prior to heating the foodstuff;
wherein heating the foodstuff includes roasting the foodstuff in a substantially dry condition;
wherein cooling the foodstuff includes exposing the foodstuff to a forced flow of air through the foodstuff;
wherein cooling the foodstuff includes bringing the temperature of the foodstuff from the first temperature to a second temperature, wherein the cooling from the first temperature to the second temperature is accomplished in a period of less than approximately 300 seconds;
wherein the second temperature being approximately 80 degrees Fahrenheit;
placing the foodstuff in a container with a closed bottom such that any nitrogen dissipating from the foodstuff passively remains in an interior of the container;
wherein the nitrogen rich environment includes at least 90 percent nitrogen; and
wherein the negative pressure condition is approximately 29 inches Hg.
